(19) United States
(12) Patent Application Publication
(10) Pub. No.: US 2007/0023265 A1
(43) Pub. Date: Feb. 1, 2007

(54) Capacitive lock switch

(76) Inventors: Kiyomitsu Ishikawa, Tokyo (JP); Yoichi Hirose, Tokyo (JP)

Correspondence Address: CERMAK & KENEALY, LLP, 515 EAST BRADDOCK RD SUITE B, Alexandria, VA, 22314, US

(21) Appl. No.: 11/460,347

(22) Filed: Jul. 27, 2006

(30) Foreign Application Priority Data
Jul. 29, 2005 (JP) 2005-221150

(51) Int. Cl. H01H 3/16

(52) U.S. Cl. 200/61.62

(57) ABSTRACT

A capacitive lock can include various circuits that allow it to operate more efficiently and with greater accuracy. For example, when a user continuously touches a door handle for a certain time duration, a sensor can be configured to retain a variation in capacitance. When the door handle is continuously touched, a time constant circuit (timer) can be provided inside the entry system and measures the contact time and unlocks a door on the assumption that the user has a will to unlock and/or operate the vehicle or other apparatus.

This application claims the priority benefit under 35 U.S.C. § 119 of Japanese Patent Application No. 2005-221150 filed on Jul. 29, 2005, which is hereby incorporated in its entirety by reference.

### BACKGROUND

1. Technical Field

The disclosed subject matter relates to a key named smart entry capable of locking/unlocking without directly operating the key when it is carried. More particularly, it is associated with an arrangement of the smart entry system for use in vehicles.

2. Description of the Related Art

In a smart entry key having a simple arrangement, an electromagnetic wave is always transmitted from the vehicle to the smart entry key carried by the user. When the user carrying the smart entry key approaches a locked door, trunk, or the like, the key receiving the electromagnetic wave from the vehicle transmits a code number. In this case, the door is unlocked if the code number matches.

When the user moves away from the vehicle and it becomes impossible to receive a respondent electromagnetic wave from the smart entry key carried by the user, the vehicle automatically locks the door. In such a system, the vehicle tends to transmit the electromagnetic wave for a long time, and sometimes infinitely, easily resulting in battery exhaustion and/or other inconveniences.

FIG. 10 shows a conventional system that is thought to improve upon this point. In accordance with typical use, when a door is opened/closed, a door handle is usually touched. Accordingly, as shown in FIG. 10, a sensor electrode 91 formed of a conductor such as a metal is provided inside a door handle body 90 formed of a resinous member. When the user touches the door handle body 90 with his/her hand, a variation occurs in a capacitance between the sensor electrode 91 assembled in the door handle body 90 and the earth/ground.

This variation is converted into a voltage through a detector circuit, for example, including an AC amplifier 93 and a rectifier 94 as shown in FIG. 11. When the output from a voltage comparator 95 reaches a certain voltage, it is used as a trigger to operate a transceiver (not shown) provided in the vehicle. The transceiver transmits an electromagnetic wave to send a signal to the entry key carried by the user to confirm the ID code of the entry key.

When the ID code matches, the vehicle is prepared for operation by doing things such as unlocking the door(s), moving the seats, and starting the engine, etc. In this case, if the vehicle parks in a well-trafficked place, passersby may unconsciously (or consciously) touch the door handle body 90. In such a case, the transceiver operates and emits the electromagnetic wave, which uselessly consumes power and places a burden on the battery. Therefore, a portion of the door handle body 90 outside the vehicular body is provided with a grounded capacitive shield plate 92 to prevent the sensor electrode 91 from causing a variation in capacitance when it is touched from outside.

Accordingly, the sensor electrode 91 causes a required variation in capacitance when the user extends his/her hand around the door handle body 90 to the inside thereof and grasps it. When the door handle is touched in such a state, the user is determined to have a will to ride on the vehicle, and a trigger operation allows the transceiver provided on the vehicle to perform certain operations.

On termination of the use of the vehicle, the transmitter on the vehicle continues transmission in principle and, when the vehicle can not receive the respondent signal from the entry key carried by the driver, the door is locked. In this method, the transmitter on the vehicle tends to operate longer, and results in an increase in battery consumption. Therefore, a mechanical lock switch 96 may be located at an appropriate position in the door handle body 90, an example of which is shown in FIG. 12. In this case, when the lock switch is pressed upon getting off the vehicle, the door is locked and the engine is immediately stopped. Alternatively, a lock sensor electrode 97 may be provided as shown in FIG. 13 instead of the mechanical lock switch 96. The lock switch 96 and the lock sensor electrode 97 require corresponding control circuits, though they are not shown in the figures (see JP-A 2002-295093).

In the above-described conventional capacitive sensors, when an outsider operates the door handle body 90 or leans against the vehicle with an interest in the vehicle or the like, a large capacitance may arise in the vicinity of the door handle body 90. In addition, a rainfall or snowfall may allow a dielectric such as water to exist in the vicinity of the door handle. In such cases, a variation may occur in capacitance associated with the sensor electrode 91, and possibly result in a trigger operation to the transceiver provided on the vehicle.

Accordingly, the transceiver mounted on the vehicle interprets the trigger operation as a request for unlocking or locking and performs transmission to the entry key, leading to consumption of the battery, or the power supply in the vehicle. When the owner carrying the entry key occasionally stands near the vehicle, another person may touch the handle body, or a rainfall may occur. Also in such a case, an erroneous operation may unlock the vehicle and start the engine or perform other functions, regardless of the will of the owner/driver.

### SUMMARY

The disclosed subject matter provides a capacitive lock switch that, in accordance with an aspect of the subject matter, can include: a metallic electrode arranged inside or in the vicinity of a door handle; a converter circuit operative to convert a variation in capacitance associated with the metallic electrode into an electrical parameter; a decision circuit operative to detect a level variation in the electrical parameter; and a time constant circuit operative to measure the time of the level variation to provide a lock signal on measurement of the variation in capacitance over a certain time.

In the disclosed subject matter, after a certain level or higher variation is detected, continuity of this level variation over a certain time is computed, followed by providing a lock signal. Accordingly, the capacitive switch can achieve locking reliably, reflecting the will of the user. In addition, cost of the lock system can be kept down, there are few installation restrictions on the switches, and the system is very convenient in terms of its operation and use.

### BRIEF DESCRIPTION OF THE DRAWINGS

FIG. 1 is a block diagram illustrative of an embodiment associated with a capacitive lock switch made in accordance with principles of the disclosed subject matter;

FIG. 2 is an illustrative view of shapes of waveforms among the blocks in the block diagram of FIG. 1;

FIG. 3 is a block diagram illustrative of another embodiment of a capacitive lock switch made in accordance with principles of the disclosed subject matter;

FIG. 4 is an illustrative view of shapes of waveforms among the blocks in the block diagram of FIG. 3;

FIG. 5 is a block diagram illustrative of an arrangement of the high-pass filter of FIG. 1;

FIG. 6 is a waveform diagram illustrative of operation of the high-pass filter;

FIG. 7 is a waveform diagram illustrative of operation of the tilt detector circuit of FIG. 5;

FIG. 8 is a block diagram illustrative of another embodiment of a capacitive lock switch made in accordance with principles of the disclosed subject matter;

FIG. 9 is a waveform diagram illustrative of operation of another embodiment of a capacitive lock switch made in accordance with principles of the disclosed subject matter;

FIG. 10 is a cross-sectional view illustrative of the structure of a door handle according to an example of related art;

FIG. 11 is a block diagram illustrative of a detector circuit according to an example of related art;

FIG. 12 is an illustrative view of a door handle according to another example of related art; and

FIG. 13 is an illustrative view of a door handle according to yet another example of related art.

### DETAILED DESCRIPTION OF EXEMPLARY EMBODIMENTS

The disclosed subject matter will be described next in detail based on the exemplary embodiments shown in the figures. The basic detector circuit of the capacitive type lock switch can be configured as shown in FIG. 1. In this case, a capacitance 1 is the target capacitance provided, for example, in a door handle, latch, or the like of the vehicle. A converter 2 is a circuit operative to convert a value of the capacitance 1 into a voltage or a digital signal. A high-pass filter 3 is a circuit operative to remove a DC component from an output signal from the converter 2. A comparator 4 is a circuit operative to binarize an output signal from the high-pass filter 3.

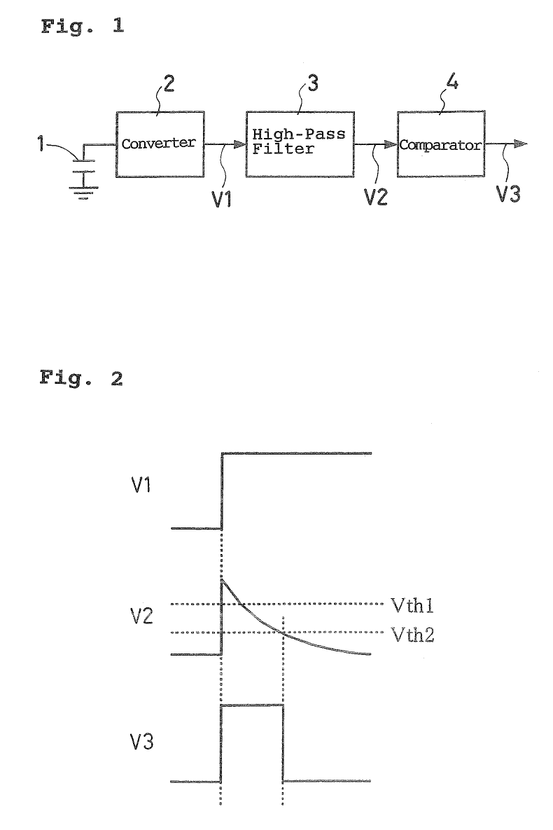

Consideration is now given to the case where a human body or the like touches the capacitance 1 to increase the capacitance 1 in FIG. 1. In this case, an output V1 from the converter 2 also increases. If the rate of increase in the capacitance 1 is sufficiently higher than a time constant of the high-pass filter 3, then the output V1 from the converter 2, an output V2 from the high-pass filter 3, and an output V3 from the comparator 4 vary as shown in FIG. 2.

In FIG. 2, Vth1 and Vth2 denote a threshold level for turning the output V3 from the comparator from low level to high level, and a threshold level for turning it from high level to low level, respectively. In this way, an increase in the capacitance 1 can be detected.

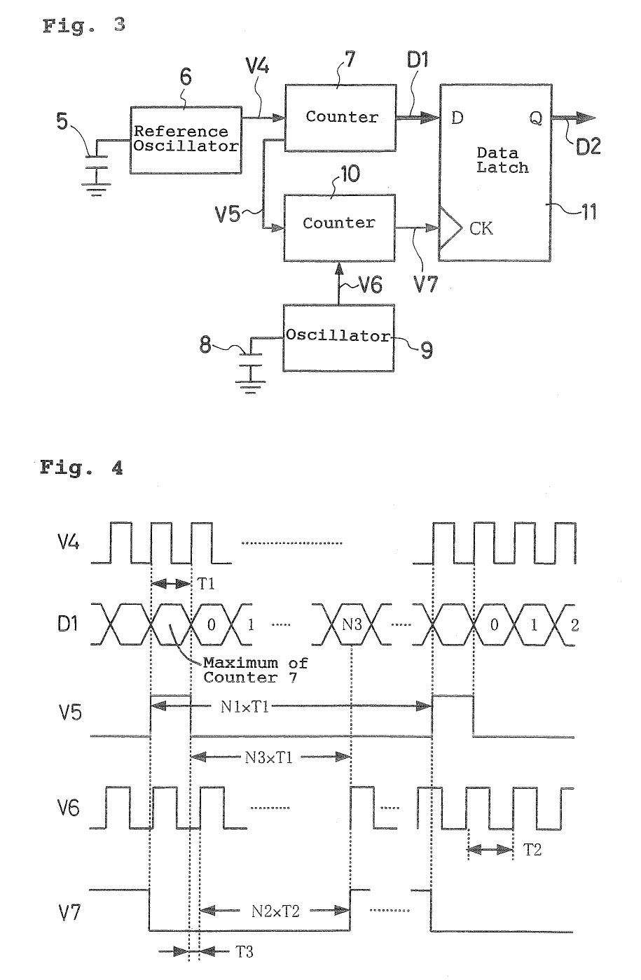

As an example of digitally detecting the variation in the capacitance 1, the converter can be configured as shown in FIG. 3. In this example, a capacitance 5 determines the oscillation period of a reference oscillator 6 and is made invariable. The capacitance 5 is defined as a reference capacitance. A capacitance 8 determines the oscillation period of an oscillator 9. The capacitance 8 is defined as a target capacitance.

The reference capacitance 5 has a value of C1 and the reference oscillator 6 has an oscillation period of T1. The oscillation period T1 of the reference oscillator 6 is proportional to the value C1 of the reference capacitance 5 and can be represented by the following expression.
(T1=C1×R1) (Expression 1)

The target capacitance 8 has a value of C2 and the oscillator 9 has an oscillation period of T2. A relation between the oscillation period T2 of the oscillator 9 and the value C2 of the target capacitance 5 can also be represented by the following expression that is similar to (Expression 1).
(T2=C2×R2) (Expression 2)

A counter 7 is considered first. The counter 7 is given an achievable maximum of N1 and has two outputs. The one output D1 increases in response to a rising edge of the output from the reference oscillator 6. The other output V5 is a one-bit signal that turns high (H) when the value of D2 reaches the achievable maximum N1. Thus, V5 provides a pulse with a pulse width of T1 and a period of (N1×T1).

A counter 10 is considered next. The counter 10 counts rising edges of the output V6 from the oscillator 9 and provides an output V7 of high (H) when the count reaches N2 or more certain times. The counter 10 is reset when the output V5 from the counter 7 turns high (H).

The output V4 from the reference oscillator, the outputs D1 and V5 from the counter 7, the output V6 from the oscillator connected to the target capacitance, and the output V7 from the counter have a relation as shown in FIG. 4. A falling edge of V5, or the reset signal to the counter 10, and a rising edge of the signal V6 fed from the oscillator 9 to the counter 10 immediately after that falling edge have a time difference of T3 therebetween. The output D1 from the counter 7 at a rising edge of the output V7 from the counter 10 has a value of N3. In this case, the following expression is realized.
(N3×T1)=(N2×T2+T3) (Expression 3)

As the achievable value of T3 ranges from 0 to T2, (Expression 3) can be written as follows if N2 is sufficiently larger than 1.
(N3×T1=N2×T2) (Expression 4)

When T1 and T2 in (Expression 4) are substituted with (Expression 1) and (Expression 2), the value N3 of the output D1 from the counter 7 at a rising edge of the output from the counter 10 is represented by the following expression.
N3={(C2×R2)/(C1×R1)}×N2 (Expression 5)

In the data latch 11 of FIG. 3, the value of input data D1 is latched in response to a rising edge of V7 and the latched value is output from D2. In this case, the value of N3 is output from D2. Consideration is given to the case where the target capacitance C2 varies from C3 to C3+C4.

When the target capacitance C2 is equal to C3, D2 has a value of N4 and when the target capacitance C2 is equal to C3+C4, D2 has a value of N5. In this case, N4 and N5 are represented by the following respective expressions.
N4={(C3×R2)/(C1×R1)}×N2 (Expression 6)
N5=[{(C3+C4)×R2}/(C1×R1)]×N2 (Expression 7)

From (Expression 6) and (Expression 7), a variation N6 in N3 when the target capacitance C2 varies from C3 to C3+C4 is represented by the following expression.
N=(N5−N4)={(C4×R2)/(C1×R1)}×N2 (Expression 8)

C1, R1, R2 and N2 in (Expression 8) are previously given constants. Accordingly, measurement of the output D2 from the data latch 11 allows the variation C4 in the target capacitance to be derived independent of the initial value C3 of the target capacitance. In the case of multiple channels, the channels can share the reference capacitance 5, the reference oscillator 6 and the counter 7.

These operations make it possible to detect a variation in capacitance due to a touch of the human body or the like. In this case, though, a touch regardless of the will of the user may possibly cause the detector to respond. To reduce this possibility, a circuit is added such that the output from the comparator responds only to a touch over a certain time T4.

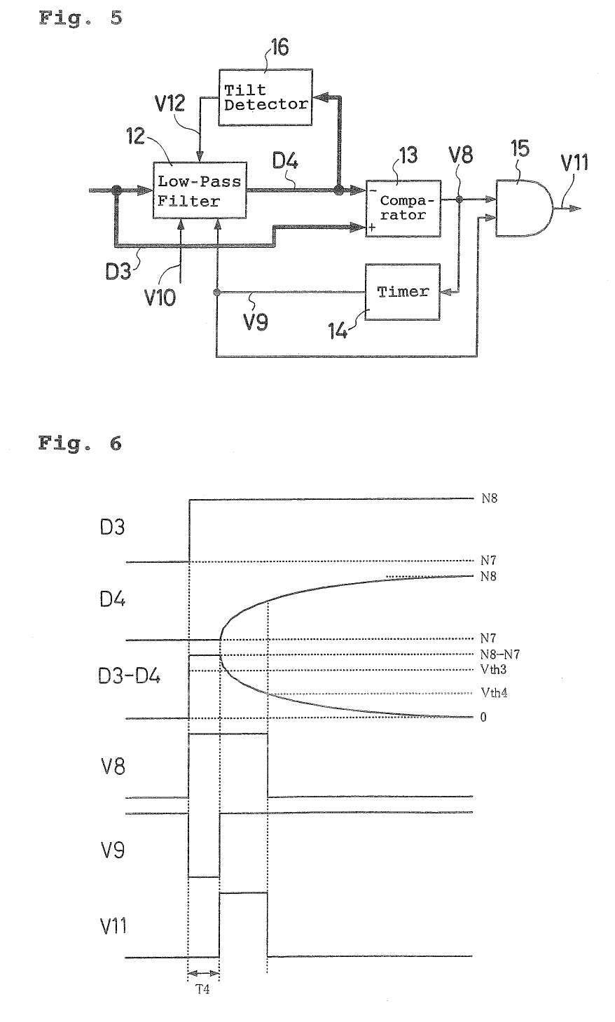

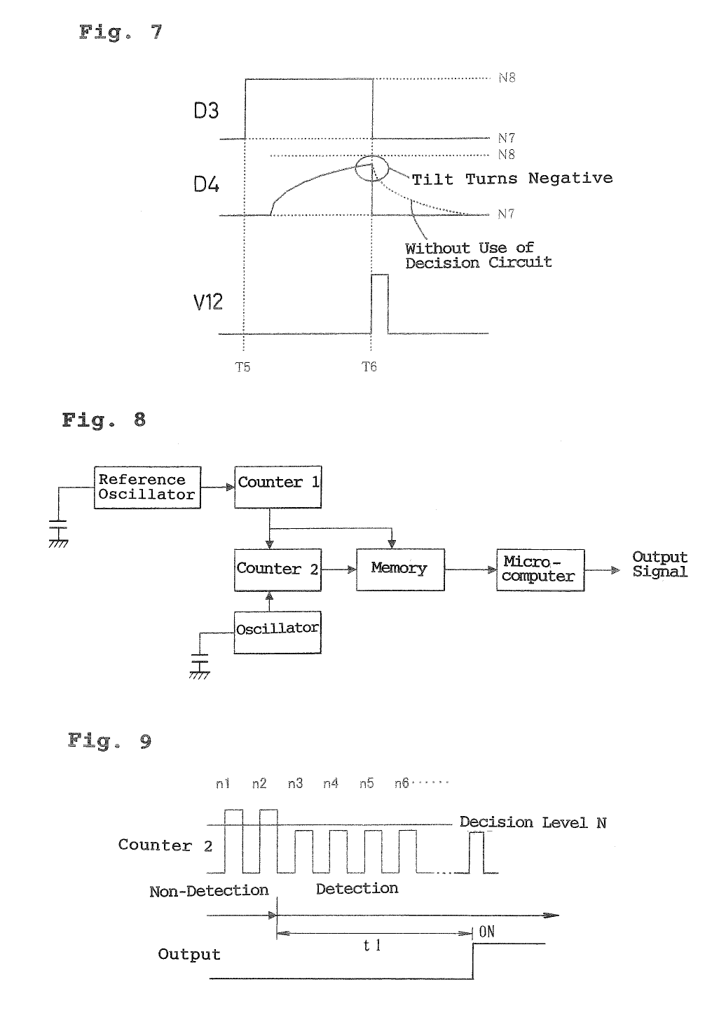

A circuit having an arrangement shown in FIG. 5 can be used for that purpose, and is used for the high-pass filter 3 and part of the comparator 4 in FIG. 1. In FIG. 5, a difference between an original signal and a signal passed through a low-pass filter 12 is used as the output from the high-pass filter 3 shown in FIG. 1.

In FIG. 5, an input signal to the low-pass filter 12 is denoted with D3 and an output signal from the low-pass filter 12 is denoted with D4. When the value of the input signal D3 varies from N7 to N8, the output signal D4 from the low-pass filter 12 varies from N7 to N8 in accordance with a time constant thereof.

In this case, subtraction of the signal that has passed through the low-pass filter 12 from the original signal yields a value of (D3−D4). Therefore, when the value of the input D3 to the low-pass filter 12 varies from N7 to N8, the value (D3−D4) from subtraction of the signal passed through the low-pass filter varies from 0 to (N8−N7). Thereafter, it gradually approaches 0 in accordance with the time constant of the low-pass filter.

The comparator 13 varies the output V8 from low (L) to high (H) at a threshold level Vth3 and high to low at a threshold level Vth4. In this case, when the variation (N8−N7) in the input signal D is higher than Vth3, the comparator 13 varies the output V8 from low to high.

A timer 14 provides an output V9 of high when the output V8 from the comparator 13 is made low. In this state, the timer 14 is kept reset. Immediately after the comparator 13 varies the output V8 from low to high, the output V9 varies from high to low. When a time T4 elapses immediately after the output V9 turns low, the output V9 turns high again.

If the target capacitance returns to the original value when the output is high, that is, the input to the low-pass filter varies from N8 to N7, D4 takes a value from N7 to N8. Therefore, the input (D3−D4) to the comparator 13 has a value within a range between (−N8) and 0. Accordingly, the output V8 from the comparator 13 becomes low. In this case, the output V9 from the timer 14 becomes high and the timer 14 is reset.

As for the low-pass filter 12, only when the output V9 from the timer 14 is high, do clock signals V9 for use in the low-pass filter 12 become effective. When the output V9 from the timer 14 is low, the clock signals V9 are ineffective.

While the timer 14 keeps the output V9 at low for the period of time T4, the low-pass filter 12 keeps the output unchanged. When the time T4 elapses after the input D3 to the low-pass filter 12 turns high, the low-pass filter 12 starts normal operation. When the output V8 from the comparator and the output V9 from the timer are both at high, the final detection signal V11 exhibits high, which is regarded as an occurrence of the variation in capacitance.

A variation in capacitance for a short time less than the time T does not vary the status of a circuit having a data retaining function, or the low-pass filter 12 and the timer 14. This is equivalent to the case where such variation in capacitance did not arise. With respect to these operations, the states of the signals are as shown in FIG. 6.

The above operations make it possible to realize a circuit operative to respond only to a variation in capacitance over a certain time T4. An occurrence of the variation in capacitance over the certain time T4 increases the output V8 from the low-pass filter 12. Thereafter, when the target capacitance is not touched, that is, the capacitance returns to the pre-detection value V7, the output D4 from the low-pass filter 12 approaches N7 in accordance with the time constant thereof.

During the process of approach of the output D4 to N7, the value of D4 is slightly higher than N7. Therefore, the level of the minus input to the comparator 13 increases to lower the sensitivity. To shorten the time of the lowered sensitivity, a tilt/slope detector circuit 16 can be provided.

The output D4 from the low-pass filter 12 is considered when the input D3 varies from N7 to N8. If the target capacitance is continuously touched, D4 varies on a curve having an asymptote to N8, with a tilt/slope of 0 or more. Thereafter, when the target capacitance is not touched, the tilt/slope of D4 reaches a value less than 0.

A variation in the tilt/slope is detected at the tilt/slope detector 16 and, if it determines that the tilt/slope is below a certain value, data is set such that the output D4 from the low-pass filter 12 reaches the value of the input D3. The longer the certain time T4, the better the erroneous operation can be prevented. In consideration of the general convenience to use, though, 0.3-1.5 seconds may be regarded as a desirable time.

FIG. 8 shows a circuit arrangement according to another embodiment of the disclosed subject matter. This circuit includes a counter 1 configured to count reference signals, and a counter 2 configured to count the outputs from the counter 1. The count in the counter 2 is sequentially stored in a memory at the timing of the output from the counter 1. A microcomputer can determine when the count varies above a certain level, and provides an ON signal when a certain or more variation continues over a set time.

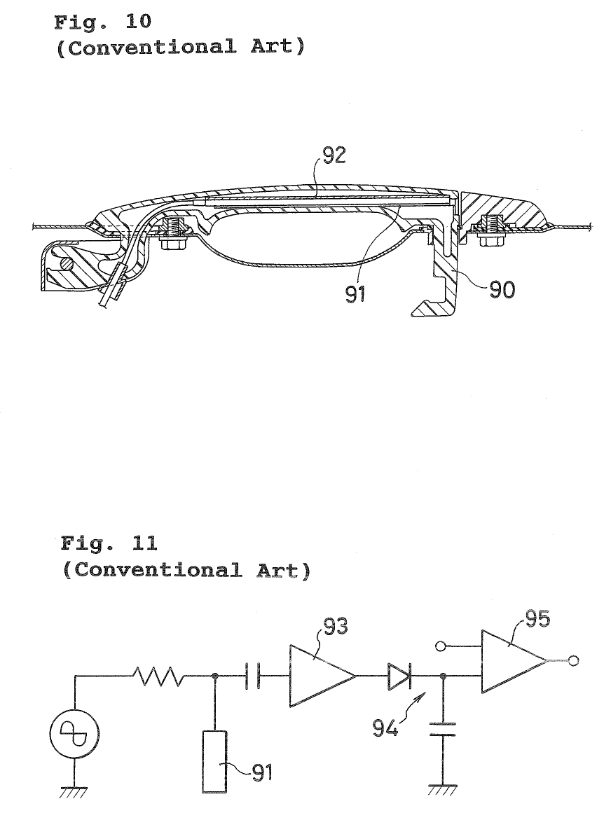

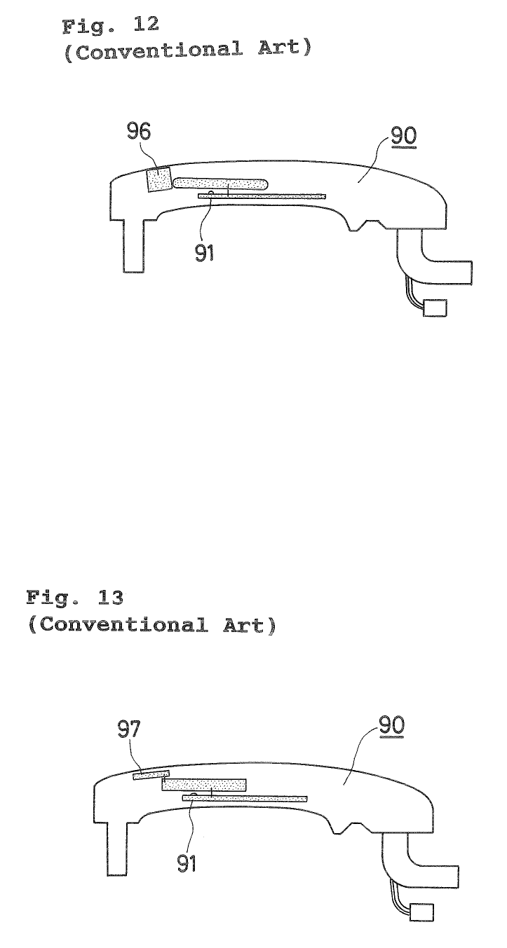

FIG. 9 shows a timing chart for the embodiment of FIG. 8. When the count n1, n2 during non-detection becomes a count lower than a certain level N (for example, as shown in n3, n4, n5, n6) and the duration continues longer than t1, an output signal is generated.

While there has been described what are at present considered to be exemplary embodiments of the invention, it will be understood that various modifications may be made thereto, and it is intended that the appended claims cover such modifications as fall within the true spirit and scope of the invention. All conventional art references described above are herein incorporated in their entirety by reference.

What is claimed is:

1. A capacitive lock switch, comprising:
an electrode located adjacent a door handle;
a converter circuit configured to convert a variation in capacitance associated with the electrode into an electrical parameter;
a decision circuit configured to detect a level variation in the electrical parameter; and
a time constant circuit configured to measure a time of duration of the level variation in the electrical parameter and to provide a lock signal upon measurement of the variation in capacitance over a certain time duration.

2. The capacitive lock switch according to claim 1, wherein the time constant circuit is configured to determine the variation in capacitance and the time duration of the level variation in the electrical parameter through a comparison of frequencies before the variation in capacitance stored at certain time intervals with frequencies after the variation in capacitance.

3. The capacitive lock switch according to claim 1, wherein the decision circuit includes a circuit configured to detect the slope/tilt of the level variation in the electrical parameter.

4. The capacitive lock switch according to claim 1, further comprising:
a detection circuit configured to detect a beginning of the variation in capacitance; and
a second time constant circuit configured to detect time duration of the variation in capacitance in conjunction with the detection circuit.

5. The capacitive lock switch according to claim 4, wherein the second time constant circuit has a time constant of 0.3-1.5 seconds.

6. The capacitive lock switch according to claim 1, further comprising:
a circuit configured to reduce a return time until capacitance becomes detectable after capacitance becomes undetectable.

7. The capacitive lock switch according to claim 3, further comprising:
a circuit configured to reduce a return time until capacitance becomes detectable after capacitance becomes undetectable.

8. The capacitive lock switch according to claim 1, wherein the electrode is a metallic electrode.

9. A capacitive lock switch, comprising:
an electrode located adjacent a door handle;
a converter circuit configured to convert a variation in capacitance associated with the electrode into an electrical parameter;
a decision circuit configured to determine from the electrical parameter whether the electrode has been contacted by a human body; and
a time constant circuit configured to measure a time of duration of the variation in capacitance and to provide a lock signal upon both measurement of the variation in capacitance over a certain time duration and a determination from the decision circuit that the electrode has been contacted by a human body.

10. The capacitive lock switch according to claim 9, wherein the electrode is a metallic electrode.

11. The capacitive lock switch according to claim 9, wherein the time constant circuit is configured to compare frequencies before the variation in capacitance stored at certain time intervals with frequencies after the variation in capacitance.

12. The capacitive lock switch according to claim 9, wherein the decision circuit includes a circuit configured to detect the slope/tilt of variation in the electrical parameter.

13. The capacitive lock switch according to claim 9, wherein the certain time duration is between 0.3 and 1.5 seconds.
